(19) United States
(12) Patent Application Publication
(10) Pub. No.: US 2024/0328813 A1
(43) Pub. Date: Oct. 3, 2024

(54) SYSTEM AND METHOD FOR DISPLAYING LOCAL ATTRACTIONS

(71) Applicants: Jim Jindrick, Tucson, AZ (US); Paul Efron, Oro Valley, AZ (US)

(72) Inventors: Jim Jindrick, Tucson, AZ (US); Paul Efron, Oro Valley, AZ (US)

(21) Appl. No.: 18/406,796

(22) Filed: Jan. 8, 2024

Related U.S. Application Data
(60) Provisional application No. 63/493,694, filed on Mar. 31, 2023.

(51) Int. Cl. G01C 21/36

(52) U.S. Cl. CPC G01C 21/3682; G06Q 30/0631

(57) ABSTRACT

A display and method for communicating characteristics and attractions in a geographical area. The display includes a map with iconographic representations of attractions, route indicators between attractions, and distance indicators measured in drive time. The distance indicator can be represented by the distance between the iconographic representations or a number expressed in minutes. The display may also include a link to a description of each attraction, which can be a quick response (QR) code or a digital map layer. The display can be a paper map to be hung in a location that is depicted on the map. The display may also include a day trip suggestion indicating a plurality of attractions that can be experienced in a day, with iconographic representations sized to represent the time required to experience the attraction.

### CROSS REFERENCE TO RELATED APPLICATION

This application claims priority to U.S. Provisional Application No. 63/493,694, filed Mar. 31, 2023 the contents of which is incorporated herein in its entirety.

### BACKGROUND OF THE INVENTION

### Field of the Invention

The present invention generally pertains to the field of geographical displays. More specifically, the invention relates to displays and methods for communicating attractions in a geographical area, indicating routes and distances between attractions, and providing additional information about the attractions. The invention further encompasses the use of such displays in promoting local businesses and facilitating tourism. Links, QR codes, or other selectable indicators may be provided to optionally access additional information.

### Description of Related Art

Navigating through unfamiliar geographical areas can often be challenging, especially when trying to locate and visit various attractions. Traditional maps provide a general layout of the area but lack specific details about the attractions, such as their proximity to each other, the estimated drive time between them, and a brief description of each attraction. This lack of information can lead to inefficient planning and navigation, resulting in wasted time and missed opportunities to visit nearby attractions.

Moreover, the increasing popularity of local businesses as tourist attractions has created a need for a more interactive and informative display that not only guides tourists to these businesses but also provides them with a brief overview of what they offer. However, existing maps and navigation tools do not provide a platform for local businesses to showcase themselves as attractions. Furthermore, planning a day trip to experience multiple attractions can be a daunting task, especially when trying to estimate the time required to visit each attraction and the travel time between them.

Current mapping and navigation tools do not provide suggestions for day trips that take into account the time required to experience each attraction and the drive time between them. There are many technological solutions incorporating mobile devices and location sensor technology to provide navigation services for vacation or sightseeing excursions. However, navigation services for vacation or sightseeing excursions often present challenges unmet by existing navigation solutions. While digital maps have become increasingly popular, there is still a demand for physical maps, especially in areas with limited internet connectivity or for individuals who prefer a tangible map. Physical maps are not limited to the small screen size of a digital device and may display more information. However, existing physical maps do not provide the same level of interactivity and information as their digital counterparts. Therefore, there is a need for a display that provides an iconographic representation of attractions in a geographical area, indicates the route and drive time between contiguous attractions, and includes a link to a description of each attraction including more detailed information. Such a display would greatly enhance the user's navigation experience, make trip planning more efficient, and promote local businesses as tourist attractions.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.
U.S. Pat. No. 8,860,588
U.S. Pub. No. 2016/0202076A1
U.S. Pub. No. 2015/0254277A1
U.S. Pub. No. 2022/0386078A1
U.S. Pat. No. 8,694,245
U.S. Pub. No. 2014/0096045A1
U.S. Pub. No. 2010/0004859A1
U.S. Pub. No. 2013/0169664A1
U.S. Pat. No. 8,489,331
U.S. Pub. No. 2014/0282075A1

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a unique display for communicating attractions in a geographical area. The display includes a map of the area with an iconographic representation of each attraction. These attractions are paired, with a first attraction and a second attraction geographically contiguous to the first. A route indicator is provided between the first and second attractions, indicating the route that would be taken between them. A distance indicator is also included, providing the distance between contiguous attractions measured in drive time for the route on the route indicator.

It is an object of the invention to provide a more useful map of a location.

It is another object of the invention to provide a graphical representation of drive time between attractions in a geographical location.

It is another object of the invention to provide a printed map for a local business in a location.

It is another object of the invention to facilitate activities near a hotel or resort.

It is another object of the invention to provide a way for local businesses to advertise in adjacent businesses.

The above and other objects may be achieved using devices involving a unique display for communicating attractions in a geographical area. The display includes a map of the area with an iconographic representation of each attraction. These attractions are paired, with a first attraction and a second attraction geographically contiguous to the first. Many attractions may be listed on the display, and references to a first attraction and a second attraction refer only to the relationship between two of the many attractions provided on the display. A route indicator is provided between the first and second attractions, indicating the route that would be taken between them. A distance indicator is also included, providing the distance between contiguous attractions measured in drive time for the route on the route indicator.

In some embodiments, the distance indicator is represented by the distance between the iconographic representations of the first and second attractions on the display and a scale. In other embodiments, the distance indicator is represented by a number written between the first and second attractions expressed in minutes. In still other embodiments, the distance indicator is represented by a drawn line, the length of which is directly proportional to the drive time.

The display may also include a link to a description of each attraction, located near the iconographic representation of the attraction. This link may be a quick response (QR) code or may include a digital map layer. The attractions on the display may include historical, natural, architectural, or linguistic attractions.

The display may be a paper map to be hung in a location that is depicted on the map. The display may also include a day trip suggestion indicating a plurality of attractions that can be experienced in a day, with the iconographic representations sized to represent the time required to experience the attraction, including drive time. The day trip suggestion may also include restaurant recommendations and a coupon to each restaurant referred to in the recommendations.

The above and other objects may be achieved using methods involving communicating attractions in a geographical area. This method includes providing the display, where the attractions include local businesses. Each local business is allowed to provide the iconographic representation of the business. The display may also include a link to the website of each local business near the iconographic representation of the local business. The method may also include displaying a paper copy of the display in a location that is depicted on the map, where the local businesses are partners with the location and pay a fee to be depicted on the map.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the FIGURES, like reference numbers refer to like elements or acts throughout the FIGURES.

FIG. 1 depicts a display in accordance with a first embodiment of the invention.

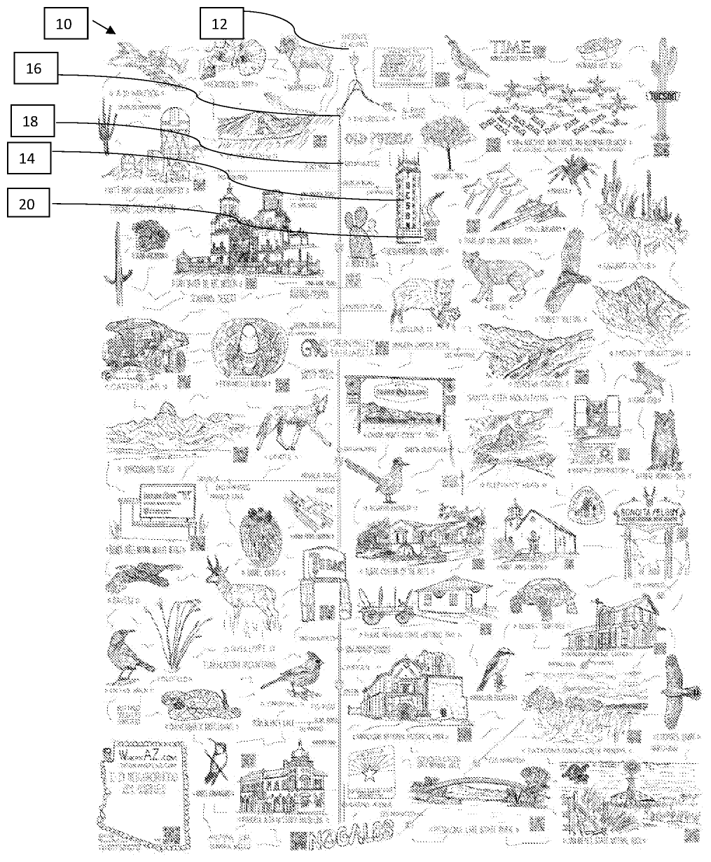

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

In one application of the invention, a display for communicating attractions in a geographical area is provided. The display includes a map of the area 10 with an iconographic representation of each attraction. The representations may be photographs, stylized illustrations, icons, paintings, mosaics, comics, cartoons, or digital renderings. The attractions may be considered as pairs with a first attraction 12 and a second attraction 14 geographically contiguous to the first attraction. A route indicator 16 is provided between the first and second attractions, indicating the route that would be taken between them. The route may be roads, landmarks, trails, public transportation routes or other methods of going from one place to another. A distance indicator 18 is also included, providing the distance between contiguous attractions measured in travel time for the route on the route indicator. Time to be spent at the attraction to fully experience the attraction may also be provided.

In some embodiments, the distance indicator 18 is represented by the distance between the iconographic representations of the first and second attractions on the display and a scale. For example, 1 millimeter in distance between icons may indicate one minute of travel time between the attractions. In other embodiments, the distance indicator 18 is represented by a number written between the first and second attractions expressed in minutes. In still other embodiments, the distance indicator 18 is represented by a drawn line, the length of which is directly proportional to the drive time. A combination of multiple distance indicators 18 may be included for clarity or visual appeal.

The display may also include a link 20 to a description of each attraction, located near the iconographic representation of the attraction. This link 20 may be a clickable link, a quick response (QR) code, shortened URL, near field communication (NFC) tag, printed code, or other linking method or may include a digital map layer. The attractions on the display may include historical, natural, architectural, or linguistic attractions. The link 20 may include a link to a digital map that will trigger a map application to open with the location of the user selecting the link 20 and directions on the map 10 application from the user's location to the attraction that was selected. The map 10 may also include other locations that the user may wish to visit or locations that have paid to advertise their site on the map. A digital coupon may be provided for the locations displayed on the map.

The display may be a paper map to be hung in a location that is depicted on the map 10. The display may also include a day trip suggestion indicating a plurality of attractions that can be experienced in a day, with the iconographic representations sized to represent the time required to experience the attraction, including drive time. An entire day may be represented with three or four iconographic representations. The day trips may include a link that allows a user to quickly load the day trip on the user's mobile device. The link may populate a map app with directions to the different attractions included on the day trip or may update a calendar application with the activities included in the day trip including the locations of the attractions. The day trip suggestion may also include restaurant recommendations and a coupon to each restaurant referred to in the recommendations.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A display for communicating attractions in a geographical area, the display comprising:
a map of the area comprising an iconographic representation of each of the attractions, the attractions comprising a plurality of paired attractions, the paired attractions having a first attraction and a second attraction geographically contiguous to the first attraction;
a route indicator between the first attraction and the second attraction, the route indicator indicating the route that would be taken between the first attraction and the second attraction;
a distance indicator of the distance between contiguous attractions measured in travel time for the route on the route indicator.

2. The display of claim 1, wherein the distance indicator is represented by the distance between the iconographic representations of the first attraction and the second attraction on the display and a scale.

3. The display of claim 1, wherein the distance indicator is represented by a number written between the first attraction and the second attraction expressed in minutes.

4. The display of claim 1, further comprising a link to a description of each attraction, wherein the link to the first attraction is near the iconographic representation of the first attraction.

5. The display of claim 4, wherein the link is a quick response (QR) code.

6. The display of claim 4, wherein the description includes a digital map layer.

7. The display of claim 1, wherein the attractions comprise at least one of a historical, natural, architectural, or linguistic attractions.

8. The display of claim 1 wherein the display is a paper map to be hung in a location that is depicted on the map.

9. The display of claim 1 wherein the distance indicator is a drawn line and wherein the length of the line is directly proportional to the drive time.

10. The display of claim 1 further comprising a day trip suggestion indicating a plurality of attractions that can be experienced in a day, wherein the day trip suggestion comprises the iconographic representations of the plurality of attractions in a suggested order.

11. The display of claim 10, wherein the iconographic representations are sized to represent the time required to experience the attraction depicted in the iconographic representation including drive time.

12. The display of claim 11 wherein the day trip suggestion further comprises restaurant recommendations and a coupon to each restaurant referred to in the restaurant recommendations.

13. A method of communicating attractions in a geographical area, the method comprising the acts of:
providing the display of claim 1, wherein the attractions comprise local businesses;
allowing each local business to provide the iconographic representation of the business.

14. The method of claim 13 wherein each local business has a website, and wherein the display further comprises a link to the website of each local business near the iconographic representation of the local business.

15. The method of claim 13 further comprising displaying a paper copy of the display in a location that is depicted on the map, wherein the local businesses are partners with the location and pay a fee to be depicted on the map.
